(19) United States
(12) Patent Application Publication
(10) Pub. No.: US 2008/0017481 A1
(43) Pub. Date: Jan. 24, 2008

(54) DUAL BELT CONVEYOR SYSTEM

(76) Inventors: Dwight A. Benninga, Clay Center, KS (US); Douglas D. Sanneman, Clay Center, KS (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/781,079

(22) Filed: Jul. 20, 2007

Related U.S. Application Data
(60) Provisional application No. 60/832,745, filed on Jul. 21, 2006.

(51) Int. Cl. B65G 15/12

(52) U.S. Cl. 198/626.5

(57) ABSTRACT

A dual belt conveyor system having a drive assembly that includes a gearbox for driving an upper belt and a lower belt between the drive assembly and a discharge assembly is disclosed. Both the upper belt and the lower belt have respective smooth and rough sides which are arranged such that the only the rough sides of the upper and lower belts are driven by the drive assembly. The gearbox includes an input shaft that drives an output shaft through a plurality of gears such that the input shaft and the output shaft rotate in opposite directions. In addition, the drive assembly includes an upper spring take-up mechanism that provides a means for automatically adjusting tension applied to the upper belt.

### RELATED APPLICATION

This patent application claims priority from U.S. provisional patent application Ser. No. 60/832,745, filed Jul. 21, 2006, which is incorporated herein by reference in its entirety.

### FIELD

This document relates to a belt conveyor system, and more particularly to a dual belt conveyor system having a gearbox.

### BACKGROUND

Dual belt conveyor systems, also known as sandwich belt conveyors, are used to transport bulk and granular materials between upper and lower belts of the conveyor system, thereby allowing such material to be transported at steep angles. During operation, the upper and lower belts require constant adjustment relative to the drive pulleys since the bulk material being transported may be squeezed too tight between the upper and lower belts and can become damaged during transportation. In addition, the longer in length a dual belt conveyor system becomes the higher the tension required between the drive pulley and the conveyor belt in order to prevent slipping of conveyor belt on the drive pulley during operation.

Experience has shown that the upper belt of the dual belt conveyor system exhibits the biggest problem regarding slippage from the upper drive pulley since the smooth side of the upper belt engages the upper drive pulley. After the dual belt conveyor system operates over a period of time the upper belt can stretch, thereby causing the upper belt to slip on the upper drive pulley. Consequently, the upper belt has to be over tightened before operation to compensate for this potential slippage with the upper drive pulley. This overtightening of the upper belt can cause the horsepower to increase and unnecessarily overload the mechanical components of the dual belt conveyor system, such as the various shafts and bearings. Accordingly, there is a need in the art for an improved dual belt conveyor system that overcomes the drawbacks of the prior art.

### SUMMARY

In one embodiment, the dual belt conveyor system may include an upper endless belt having a smooth side and a rough side, where the upper endless belt is driven by an upper drive pulley such that at least a portion of the upper drive pulley for driving the upper endless belt is along the rough side, and a lower endless belt including a smooth side and a rough side, where the lower endless belt is driven by a lower drive pulley such that at least a portion of the lower drive pulley for driving the lower endless belt is along the rough side

In another embodiment, the dual belt conveyor system comprising a drive assembly for driving an upper endless belt and a lower endless belt wherein the upper endless belt is directly engaged with an upper drive pulley and an upper take-up pulley, and an upper belt take-up mechanism being operatively associated with the upper take-up pulley, the upper belt take-up pulley providing a means for automatically adjusting the tension on the upper endless belt.

In yet another embodiment, a dual belt conveyor system may include a drive assembly operatively engaged with a gearbox having interlocking gears for driving an upper endless belt and a lower endless belt with the gearbox including an input shaft operatively engaged with a lower output shaft through the interlocking gears, the drive assembly including an upper drive pulley and a lower drive pulley, the lower drive pulley being directly engaged with the lower output shaft, the upper and lower drive pulleys being directly engaged with the upper endless belt and a lower endless belt, respectively, wherein operating the gearbox causes the input shaft to rotate in one direction, while the lower output shaft is rotated in an opposite direction.

Implementation of the above embodiments may include one or more of the following features:

The rough side of the upper endless belt and the rough side of the lower endless belt includes a plurality of protrusions.

The plurality of protrusions on the rough side of the upper endless belt and the rough side of the lower endless belt are crescent shaped.

The rough side of the upper endless belt faces the rough side of the lower endless belt face.

The rough side of the upper endless belt produces an enhanced tactile engagement between the upper endless belt and the upper drive pulley.

The upper drive pulley and the lower drive pulley are operatively mounted within a drive assembly.

The drive assembly further includes a first set of pulleys engageable with the upper endless belt and a second set of pulleys engageable with the lower endless belt.

The first and second sets of pulleys engage the smooth side of the upper endless belt and the smooth side of the lower endless belt.

The dual belt conveyor system further includes a gearbox for driving the upper drive pulley and the lower drive pulley wherein the upper drive pulley only engages the rough side of the upper endless belt and wherein the lower drive pulley only engages the rough side of the lower endless belt.

The upper take-up mechanism includes a take-up guide bar operatively engaged with the upper take-up pulley such that movement along the take-up bar automatically adjusts tension on the upper endless belt.

The upper belt take-up further mechanism includes an adjustment spring and an adjustment bolt operatively associated with the take-up guide bar for providing a means to regulate the position of the upper take-up pulley.

The upper take-up mechanism includes a tension indicator for visually indicating the operating tension range being applied to the upper take-up pulley.

The upper belt take-up mechanism is positioned to create a region of low tension between the upper drive pulley and the upper take-up pulley.

The lower endless belt is directly engaged with a lower drive pulley and a lower take-up pulley, the lower take-up pulley being operatively associated with a lower belt take-up mechanism that provides a means for automatically adjusting the tension on the lower endless belt.

The upper drive pulley is operatively associated with the upper output shaft.

The upper output shaft is operatively associated with the input shaft through an upper belt conveyor drive that provides a means to rotate the upper output shaft in the same direction as the input shaft.

The upper belt conveyor drive comprises a plurality of sprockets that drive a timing belt.

The plurality of sprockets includes a first sprocket, second sprocket, and third sprocket, the first sprocket is engageable with the input shaft and the second sprocket is engageable with the upper output shaft.

The input shaft is operatively engaged with a driveline shaft associated with an external vehicle that provides a means for operating the gearbox.

The input shaft is operatively engaged with an electric drive assembly that provides a means for operating the gearbox.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1 is a perspective view of the dual belt conveyor system;

FIG. 2 is a side view of a dual belt conveyor of the dual belt conveyor system;

FIG. 3 is a simplified side view illustration of upper and lower belts and associated pulleys of the dual belt conveyor;

FIG. 3A is an enlarged view of FIG. 3 showing the drive end of the dual belt conveyor;

FIG. 4A is an illustration of a rough side of the upper and lower belts;

FIG. 4B is an illustration of a smooth side of the upper and lower belts;

FIG. 5 is a side view of the drive assembly;

FIG. 5A is an enlarged view of the drive assembly;

FIG. 6 is an opposite side view of the drive assembly showing a gearbox and upper belt conveyor drive;

FIG. 7 is an exploded view of the drive assembly showing the various pulleys, rollers and shafts;

FIG. 8 is a top view of the gearbox and related structural elements;

FIG. 9 is a side view of the discharge end of the dual belt conveyor;

FIG. 10 is a simplified illustration of a roller support arrangement;

FIG. 11 is another side view of a discharge assembly of the dual belt conveyor;

FIG. 12 is a top view of the discharge assembly;

FIG. 13 is a side view of an electric drive assembly; and

FIG. 14 is a top view of the electric drive assembly.

Corresponding reference characters indicate corresponding elements among the view of the drawings. The headings used in the figures should not be interpreted to limit the scope of the claims.

### DETAILED DESCRIPTION

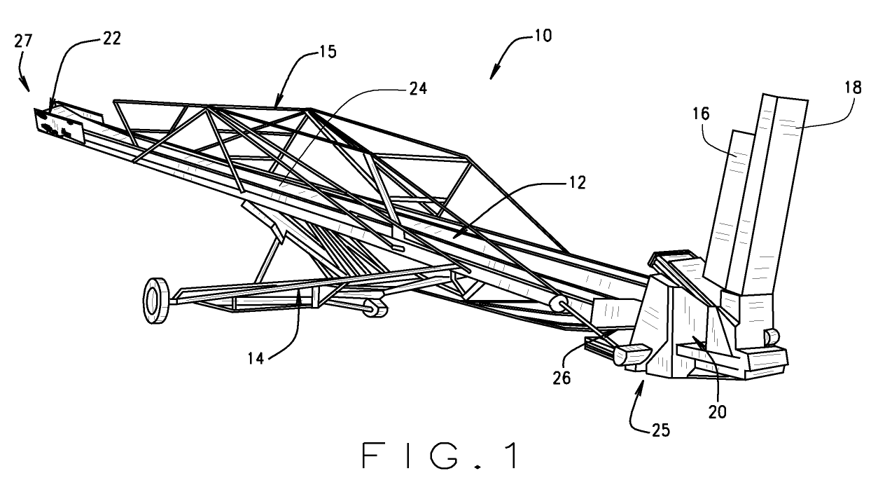

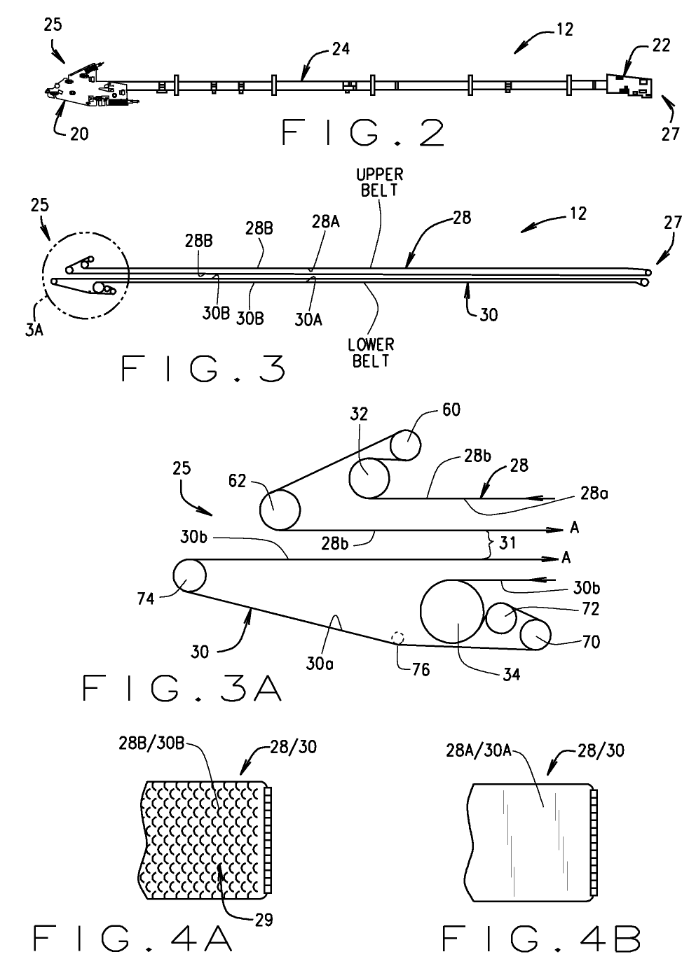

Referring to the drawings, an embodiment of the dual belt conveyor system is illustrated and generally indicated as 10 in FIG. 1. In one embodiment the dual belt conveyor system 10 may include a dual belt conveyor 12 that includes a pair of dual-sided upper and lower endless loop belts 28 and 30 extending along a conveyor tube 24 to convey a material (not shown) from a drive end 25 to a discharge end 27 of the dual belt conveyor 12 as shown in FIGS. 2 and 3. A drive assembly 20 is operatively mounted to the drive end 25 of the dual belt conveyor 12 to drive the upper and lower belts 28 and 30 between the drive assembly 20 and a discharge assembly 22 located at the discharge end 27. Material to be conveyed by the dual belt conveyor 12 is fed through a hopper 16 and separate feed conveyer assembly 18 aligned with the drive end 25 of the dual belt conveyor 12 and then conveyed between the upper and lower belts 28 and 30 along the conveyor tube 24 to be discharged through the discharge assembly 22. The dual belt conveyor 12 may be elevated and supported by an undercarriage assembly 14 such that the discharge end 27 may be elevated relative to the drive end 25. In addition, the dual belt conveyor system 10 may further include a conveyor truss assembly 15 for supporting the dual belt conveyor 12.

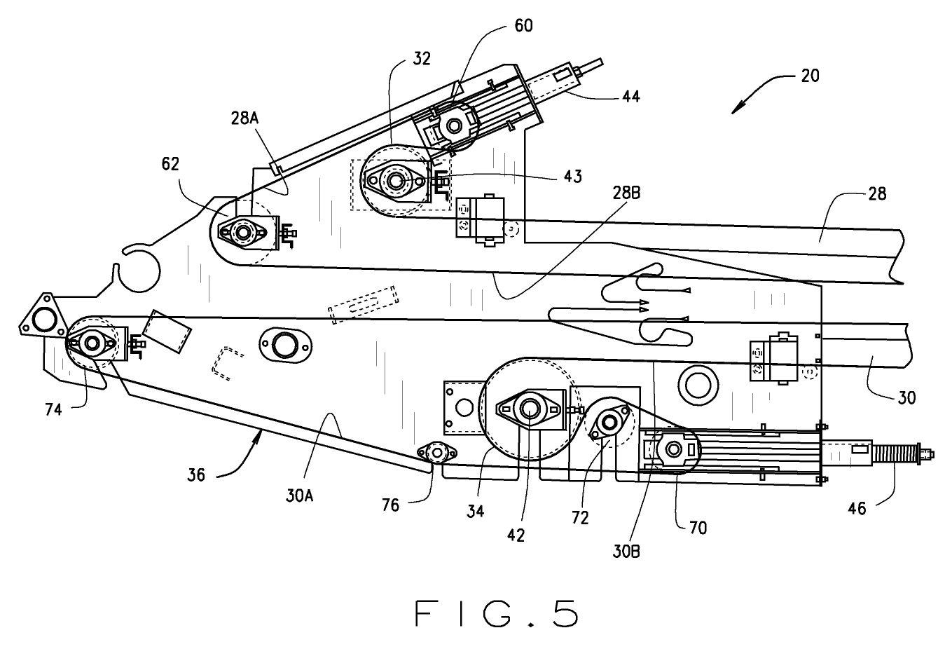

Referring to FIGS. 3, 4A and 4B, the upper belt 28 may define a smooth side 28a and a rough side 28b. In one embodiment, the rough side 28b of upper belt 28 may define a plurality of crescent-shaped protrusions 29 adapted to provide a tactile gripping surface to the rough side 28b of upper belt 28, although other embodiments may have differently configured protrusions. Similarly, the lower belt 30 also may define a smooth side 30a and a rough side 30b. As shown, the rough sides 28b and 30b of upper and lower belts 28 and 30, respectively, are oriented to face each other when mounted between the drive assembly 20 and the discharge assembly 22 so as to define a space 31 where the material may be conveyed from the drive end 25 to the discharge end 27 between the upper and lower belts 28 and 30. As further shown, the upper and lower belts 28 and 30 are operatively engaged and associated with a respective series of pulleys and rollers located at the drive assembly 20 for driving the upper and lower belts 28 and 30 and the discharge assembly 22 for discharging material as shall be discussed in greater detail below.

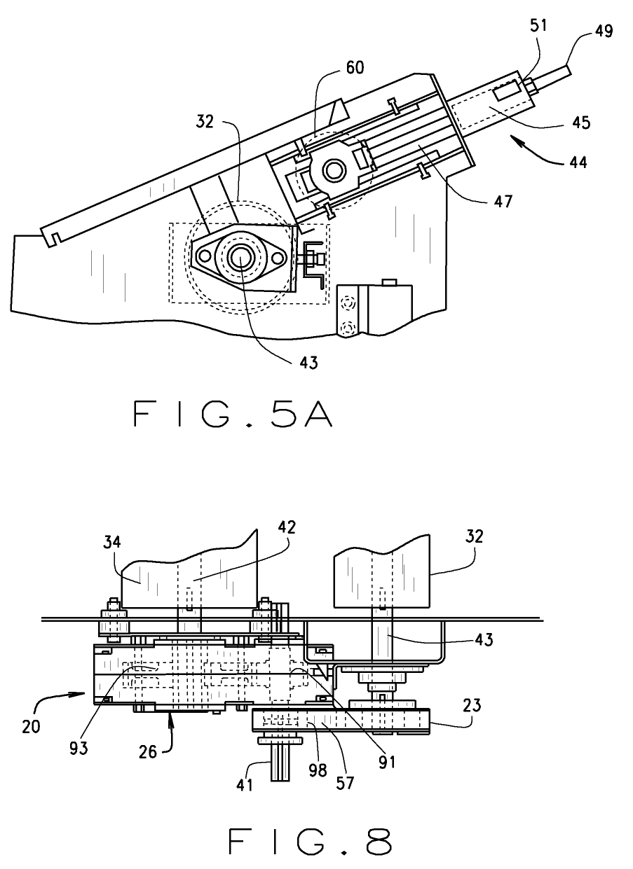

As shown in FIG. 3A, the upper belt 28 is operatively engaged and driven by an upper drive pulley 32. In addition, the upper belt 28 is operatively engaged to a take-up pulley 60 that maintains a predetermined degree of tension to the upper belt 28 and a tail pulley 62 which are collectively supported by a frame 36 (FIG. 5) of the drive assembly 20. The upper belt 28 is arranged between the pulleys 32, 60, and 62 such that the rough side 28b of the upper belt 28 only contacts the upper drive pulley 32, thereby providing a greater coefficient of friction between the upper drive pulley 32 and the upper belt 28.

This arrangement of the rough side 28b of the upper belt 28 engaging the upper drive pulley 32 requires less starting horsepower than had the smooth side 28a of the upper belt 28 been in similar contact with the upper drive belt 32. Similarly, the lower belt 30 is operatively engaged and driven by a lower drive pulley 34. As shown, the lower belt 30 is also operatively engaged to snub pulley 72, a take-up pulley 70, a hold down pulley 76, and a tail pulley 74 for driving the lower belt 30. The lower belt 30 operatively engages pulleys 34, 70,72, 74, and 76 such that only the rough side 30b of the lower belt 30 engages the lower drive pulley 34, thereby providing a greater coefficient of friction between the lower drive pulley 34 and the lower belt 30. As such, the arrangement of the upper and lower belts 28 and 30 positioned within the drive assembly 20 as described above permits the rough sides 28b and 30b of the upper and lower belts 28 and 30, respectively, to face one another along space 31 as the belts 28 and 30 travel between the drive assembly 20 and the discharge assembly 22.

Referring now to FIG. 5, the drive assembly 20 and the arrangement of the upper and lower pulley systems will be discussed in greater detail. As noted above, the upper belt 28 may be driven by upper drive pulley 32 along take-up pulley 60 and tail pulley 62. In addition, the upper take-up pulley 60 is operatively engaged with an upper belt take-up mechanism 44 that provides a spring loaded tensioning means that automatically takes up any slack in the upper belt 28. By positioning the upper belt take-up pulley 60 on the frame 36 of the drive assembly 20 directly after the upper drive pulley 32, a region of low tension between pulleys 32 and 60 is created relative to the upper belt 28 suitable for the incorporation of the spring-loaded tensioning mechanism 44. The use of springs in the take-up mechanism 44 allows for even lower belt tensions to be used since the springs compensate for the starting forces initially applied to the upper belt 28 when the dual belt conveyor 12 begins operation.

Similarly, the lower take-up pulley 70 is operatively associated with a lower belt take-up mechanism 46 that provides an identical function as the upper belt take-up mechanism 44. The placement of both the upper belt and lower belt take-up mechanisms 44 and 46, respectively, on the frame 36 of the drive assembly 20 allows the operator to monitor and adjust the tension on the upper and lower belts 28 and 30 without lowering or repositioning the dual belt conveyor 12.

Referring to FIGS. 5 and 5A, the upper belt take-up mechanism 44 includes a take-up guide bar 47 that is directly engaged with the upper take-up pulley 60 for providing a means of automatically backing off tension applied to the upper belt 28. Further, the upper belt take-up mechanism 44 includes an adjustment bolt 49 engaged to an adjustment spring 45 that collectively regulate the position of the upper take-up pulley 60 along take-up guide bar 47 by the upper belt take-up mechanism 44 such that the upper belt 28 is automatically spring tensioned as well as being easily accessible by the operator.

In one embodiment, tightening or loosening the adjustment bolt 49 will compress or stretch the adjustment spring 45, thereby withdrawing or extending the take-up guide bar 47 and the upper take-up pulley 60 in relation to the upper drive pulley 32. This tightening or loosening of the adjustment bolt 49 in turn decreases or increases the tension on the upper belt 28 by the upper belt take-up mechanism 44. The upper belt take-up mechanism 44 may also include a high and low tension indicator 51 that serves as a visual reference device to inform the operator of the desired operating tension range of the take-up mechanism 44. The approximate tension of the upper take-up pulley 60 is indicated by the location of a washer (not shown) attached to the end of the adjustment spring 45.

Similarly, the lower take-up pulley 70 is operatively engaged with the lower belt take-up mechanism 46 that includes the same components as the upper belt take-up mechanism 44. As such, the lower belt take-up mechanism 46 operates in the same fashion to automatically adjust the tension of the lower belt 30.

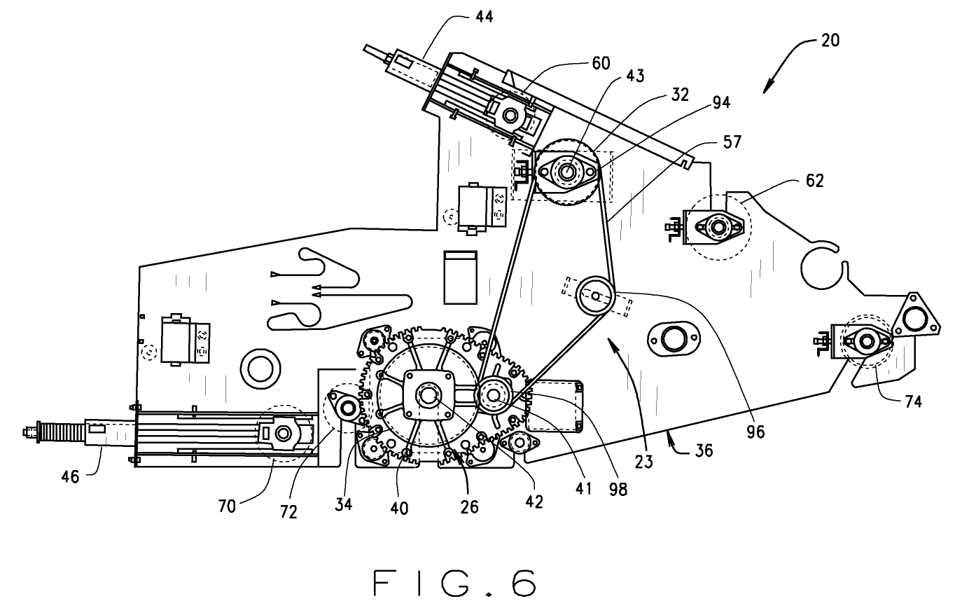

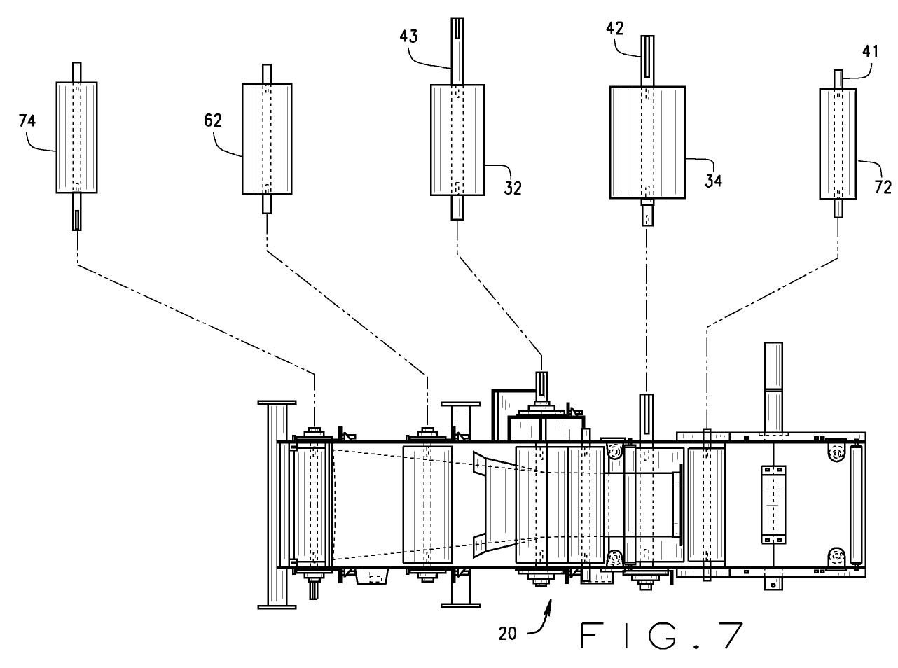

Referring to FIGS. 6 and 7, the drive assembly 20 further includes a parallel shaft gearbox 26 encased inside a gearbox casing 40 on the frame 36 of the drive assembly 20. The gearbox 26 provides a means for driving the upper and lower drive pulleys 32 and 34 using an arrangement of shafts, gears and sprockets. As shown, the gearbox 26 may include an input shaft 41 operatively associated with both the upper and lower output shafts 43 and 42 that rotate the upper and lower drive pulleys 32 and 34, respectively. The upper output shaft 43 is directly engaged to the upper drive pulley 32, while the lower output shaft 42 is directly engaged to the lower drive pulley 34.

In one embodiment, a driveline shaft (not shown) may be adapted for operative engagement with the gearbox 26 through the input shaft 41 at one end while the opposite end of the driveline shaft is engaged to a vehicle, such as a tractor (not shown), for providing rotational movement to the input shaft 41 from operation of the tractor. When the input shaft 41 rotates in one direction, the lower belt output shaft 42 rotates in the opposite direction through the interlocking gears of the gearbox 26. Conversely, when the input shaft 41 rotates in one direction, the upper output shaft 43 is rotated in the same direction as the input shaft 41.

Referring to FIG. 8, the rotational force applied to input shaft 41 by the driveline shaft is transmitted to the parallel lower output shaft 42 through the interlocking of input gear 91 with output gear 93, which are housed within the gearbox 26. As shown, input gear 91 is directly attached to input shaft 41 and output gear 93 is directly attached to lower belt output shaft 42 such that rotation of input gear 91 in one rotates the output gear 93 in the opposite direction including respective shafts 41 and 42. In one embodiment, the gears 91 and 93 are engaged in a down gearing arrangement having a gearing ratio of 2.5:1, although other ratios are contemplated.

In one arrangement shown in FIGS. 6 and 7, rotational movement applied to input shaft 41 may be transferred to the upper output shaft 43 that drives the upper drive pulley 32 through an upper belt conveyor drive 23. The upper belt conveyor drive 23 may include a cogged style synchronous timing belt 57 operatively engaged to a series of sprockets 94, 96, and 98. In particular, sprocket 98 is engaged to input shaft 41 which drives the upper belt conveyor drive 23, while sprocket 94 is operatively engaged to upper output shaft 43 for driving the upper drive pulley 32 as the sprocket 94 is caused to rotate. The timing belt 57 and the sprocket 96 are situated such that the upper belt 28 and the lower belt 30 rotate at the same rate of speed.

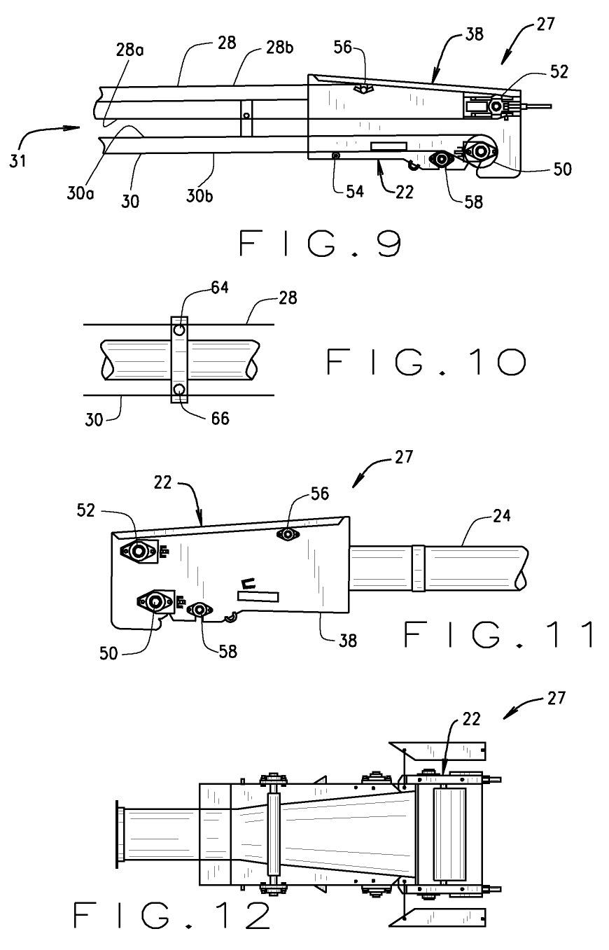

Referring now to FIGS. 9, 11, and 12, the discharge assembly 22 is located at the discharge end 27 of the dual belt conveyor 12 and may be supported by a discharge housing 38 that is attached to the conveyor tube 24. During operation, upper and lower belts 28 and 30 enter the discharge assembly 22 such that the rough side 30b of the lower belt 30 traverses downwardly around a lower head pulley 50, thereby separating the rough side 30b of the lower belt 30 from the rough side 28b of the upper belt 28 and discharging the material (not shown) from the space 31 defined between the upper and lower belts 28 and 30. The snub pulley 58 and return roller 54 maintain contact with the rough side 30b of the lower belt 30 as it returns along the conveyor tube 24. In addition, the rough side 28b of the upper belt 28 traverses upwardly around take-up pulley 52. Tension on the smooth surface 28a of the upper belt 28 is maintained by contact with support roller 56 as the upper belt 28 returns downward towards the drive end 25 of the dual belt conveyor 12. The support roller 56 functions to raise the upper belt 28 to the proper elevation during operation.

Referring to FIGS. 2 and 10, a plurality of upper return rollers 64 with corresponding lower return rollers 66 are operatively engaged to the upper and lower belts 28 and 30, respectively, for supporting belts 28 and 30 along the conveyor tube 24 during operation of the dual belt conveyor 12. In one embodiment, the dual belt conveyor 12 may include pairs of upper and lower return rollers 64 and 66 stationed equidistantly along the conveyor tube 24. As noted above, the support roller 56 raises the upper belt 28 in order to match the elevation of the return rollers 64.

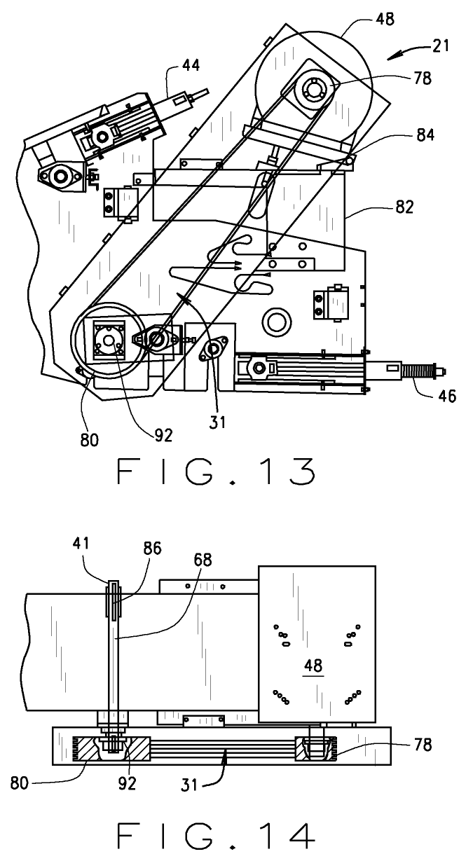

In one embodiment shown in FIGS. 13 and 14, the dual belt conveyor system 10 may include an electric drive assembly 21 that provides an alternative means for driving the dual belt conveyor 12 if the user does not desire to use the driveline shaft to accomplish the same function. The electric drive assembly 21 may be operatively engaged to the drive assembly 22, and in particular with the input shaft 41 of the gearbox 26. As shown, the electric drive assembly 21 may include a motor 48 mounted on a motor mount plate 84 engaged to a motor mount support 82. The motor 48 may be capable of driving a driven sheave 80 operatively engaged to rotate the input shaft 41 of the gearbox 26 during operation of the motor 48.

In operation, the motor 48 rotates a motor sheave 78 engaged to a plurality of belts 31 that collectively drive the driven sheave 80 when the motor 48 is made operational. The driven sheave 80 may include a bushing 92 that engages the driven sheave 80 with an electric drive connecting shaft 68. A shaft coupler 86 couples the electric drive connecting shaft 68 with the input shaft 41 for driving the gearbox 26. As such, the electric drive assembly 21 allows the user to operate the dual belt conveyor 12 without use of a driveline shaft for attachment to the gearbox 26.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A dual belt conveyor system comprising:
an upper endless belt including a smooth side and a rough side, where the upper endless belt is driven by an upper drive pulley such that at least a portion of the upper drive pulley for driving the upper endless belt is along the rough side, and
a lower endless belt including a smooth side and a rough side, where the lower endless belt is driven by a lower drive pulley such that at least a portion of the lower drive pulley for driving the lower endless belt is along the rough side.

2. The dual belt conveyor system according to claim 1, wherein the rough side of the upper endless belt and the rough side of the lower endless belt includes a plurality of protrusions.

3. The dual belt conveyor system according to claim 2, wherein the plurality of protrusions on the rough side of the upper endless belt and the rough side of the lower endless belt are crescent shaped.

4. The dual belt conveyor system according to claim 1, wherein the rough side of the upper endless belt faces the rough side of the lower endless belt face.

5. The dual belt conveyor system according to claim 1, wherein the rough side of the upper endless belt produces an enhanced tactile engagement between the upper endless belt and the upper drive pulley.

6. The dual belt conveyor system according to claim 1, wherein the upper drive pulley and the lower drive pulley are operatively mounted within a drive assembly.

7. The dual belt conveyor system according to claim 6, wherein the drive assembly further includes a first set of pulleys engageable with the upper endless belt and a second set of pulleys engageable with the lower endless belt.

8. The dual belt conveyor system according to claim 7, wherein the first and second sets of pulleys engage the smooth side of the upper endless belt and the smooth side of the lower endless belt.

9. The dual belt conveyor system according to claim 1, further comprising a gearbox for driving said upper drive pulley and said lower drive pulley wherein said upper drive pulley only engages said rough side of said upper endless belt and wherein said lower drive pulley only engages said rough side of said lower endless belt.

10. A dual belt conveyor system comprising:
a drive assembly for driving an upper endless belt and a lower endless belt wherein the upper endless belt is directly engaged with an upper drive pulley and an upper take-up pulley, and
an upper belt take-up mechanism being operatively associated with said upper take-up pulley, said upper belt take-up pulley providing a means for automatically adjusting the tension on said upper endless belt.

11. The dual belt conveyor system according to claim 10, wherein the upper take-up mechanism includes a take-up guide bar operatively engaged with the upper take-up pulley such that movement along the take-up bar automatically adjusts tension on said upper endless belt.

12. The dual belt conveyor system according to claim 11, wherein the upper belt take-up further mechanism includes an adjustment spring and an adjustment bolt operatively associated with said take-up guide bar for providing a means to regulate the position of the upper take-up pulley.

13. The dual belt conveyor system according to claim 10, wherein the upper take-up mechanism includes a tension indicator for visually indicating the operating tension range being applied to said upper take-up pulley.

14. The dual belt conveyor system according to claim 10, wherein the upper belt take-up mechanism is positioned to create a region of low tension between the upper drive pulley and the upper take-up pulley.

15. The dual belt conveyor system according to claim 10, wherein the lower endless belt is directly engaged with a lower drive pulley and a lower take-up pulley, said lower take-up pulley being operatively associated with a lower belt take-up mechanism that provides a means for automatically adjusting the tension on said lower endless belt.

16. A dual belt conveyor system comprising:
a drive assembly operatively engaged with a gearbox having interlocking gears for driving an upper endless belt and a lower endless belt, said gearbox comprising an input shaft operatively engaged with a lower output shaft through said interlocking gears, said drive assembly including an upper drive pulley and a lower drive pulley, said lower drive pulley being directly engaged with the lower output shaft, said upper and lower drive pulleys being directly engaged with said upper endless belt and a lower endless belt, respectively, wherein operating said gearbox causes the input shaft to rotate in one direction, while the lower output shaft is rotated in an opposite direction.

17. The dual belt conveyor system according to claim 16, wherein the upper drive pulley is operatively associated with the upper output shaft.

18. The dual belt conveyor system according to claim 17, wherein the upper output shaft is operatively associated with the input shaft through an upper belt conveyor drive that provides a means to rotate said upper output shaft in the same direction as said input shaft.

19. The dual belt conveyor system according to claim 18, wherein the upper belt conveyor drive comprises a plurality of sprockets that drive a timing belt.

20. The dual belt conveyor system according to claim 19, wherein said plurality of sprockets includes a first sprocket, second sprocket, and third sprocket, said first sprocket is engageable with the input shaft and said second sprocket is engageable with the upper output shaft.

21. The dual belt conveyor system according to claim 16, wherein the input shaft is operatively engaged with a driveline shaft associated with an external vehicle that provides a means for operating said gearbox.

22. The dual belt conveyor system according to claim 16, wherein the input shaft is operatively engaged with an electric drive assembly that provides a means for operating said gearbox.
